(19) United States
(12) Patent Application Publication
(10) Pub. No.: US 2024/0149813 A1
(43) Pub. Date: May 9, 2024

(54) VEHICLE ELECTRIC POWER SUPPLY DEVICE, CONTROL METHOD, AND STORAGE MEDIUM

(71) Applicant: TOYOTA JIDOSHA KABUSHIKI KAISHA, Toyota-shi (JP)

(72) Inventor: Koichi KOJIMA, Toyota-shi (JP)

(73) Assignee: TOYOTA JIDOSHA KABUSHIKI KAISHA, Toyota-shi (JP)

(21) Appl. No.: 18/458,319

(22) Filed: Aug. 30, 2023

(30) Foreign Application Priority Data
Nov. 4, 2022 (JP) 2022-177633

(51) Int. Cl. B60R 16/033; H02J 7/00

(52) U.S. Cl. CPC B60R 16/033; H02J 7/0029; B60L 53/60

(57) ABSTRACT

A vehicle electric power supply device includes an electric power storage device, a relay device, an electric current sensor, and a control device. The control device instructs an external electric power supply to stop outputting supplied electric power when an abnormality in the electric current value is detected during charging of the electric power storage device. The control device also controls a timing of cutting off a switch of the relay device, based on a state of the electric current value and a state of an amount of electric power charged to the electric power storage device, after the instruction to stop output.

### CROSS-REFERENCE TO RELATED APPLICATION

This application claims priority to Japanese Patent Application No. 2022-177633 filed on Nov. 4, 2022 incorporated herein by reference in its entirety.

### BACKGROUND

### 1. Technical Field

The present disclosure relates to an electric power supply device for a vehicle.

### 2. Description of Related Art

Japanese Unexamined Patent Application Publication No. 2020-048257 discloses an electric power transmission device that supplies electric power to a vehicle. In this technology, when a surge electric current caused by a lightning strike or the like occurs while electric power is being supplied toward the vehicle from an external electric power supply connected to the electric power transmission device, the electric power transmission device performs control to cut off a breaker device (hereinafter referred to as “relay device”) provided on an electric power supply path between the external electric power supply and the vehicle.

### SUMMARY

Now, abnormalities regrading external electric power supplies include cases in which a great electric current such as a surge electric current is generated, and other cases are conceivable as well. In the latter case of an abnormality regarding the external electric power supply, the relay device is not automatically cut off as long as the magnitude of electric current flowing over the electric power supply path between the external electric power supply and the vehicle satisfies a reference value. The reference value is set to a value lower than an electric current value at which the relay device fuses. In this case, the vehicle instructs the external electric power supply to stop outputting the supplied electric power therefrom, and following output of the supplied electric power being stopped, the relay device is cut off.

However, cases can be assumed in which the output of the supplied electric power from the external electric power supply is not stopped even though the vehicle instructs the external electric power supply to stop output of the supplied electric power. In this case, the relay device will not be cut off even after a state is reached in which the battery of the vehicle (hereinafter referred to as “electric power storage device”) is fully charged, and the electric power storage device will continue to be charged with the supplied electric power output from the external electric power supply. Accordingly, there is a concern that the electric power storage device will enter a state of being overcharged, which may lead to failure or deterioration of the electric power storage device.

An object of the present disclosure is to provide technology capable of suppressing overcharging of an electric power storage device when an abnormality occurs in an external electric power supply during charging of the electric power storage device.

A first perspective relates to a vehicle electric power supply device. A vehicle electric power supply device includes an electric power storage device that is charged with supplied electric power output from an external electric power supply, a relay device provided between the external electric power supply and the electric power storage device, an electric current sensor that measures an electric current value of an electric power line that connects the external electric power supply and the electric power storage device, and a control device that is connected to each of the electric power storage device, the relay device, and the electric current sensor, and that controls the relay device. The control device instructs the external electric power supply to stop outputting the supplied electric power when an abnormality in the electric current value is detected during charging of the electric power storage device. The control device is also configured to control a timing of cutting off a switch of the relay device, based on a state of the electric current value and a state of an amount of electric power charged to the electric power storage device, after the instruction to stop output.

A second perspective relates to a vehicle electric power supply device having the following features in addition to the first perspective. The control device is configured to, after the instruction to stop output, keep the switch of the relay device on until a certain amount of time elapses from when the electric current value becomes no lower than a threshold value, when the amount of electric power charged to the electric power storage device is less than a predetermined amount of electric power.

A third perspective relates to a vehicle electric power supply device having the following features in addition to the first perspective. The control device is configured to, after the instruction to stop output, keep the switch of the relay device on from when the electric current value becomes no lower than a threshold value, until the amount of electric power charged to the electric power storage device becomes no less than a predetermined amount of electric power.

A fourth perspective relates to a control method of controlling a relay device in a vehicle electric power supply device that includes an electric power storage device that is charged with supplied electric power output from an external electric power supply, the relay device provided between the external electric power supply and the electric power storage device, and an electric current sensor that measures an electric current value of an electric power line that connects the external electric power supply and the electric power storage device. The control method includes instructing the external electric power supply to stop outputting the supplied electric power when an abnormality in the electric current value is detected during charging of the electric power storage device, and controlling a timing of cutting off a switch of the relay device, based on a state of the electric current value and a state of an amount of electric power charged to the electric power storage device, after the instruction to stop output.

A fifth perspective relates to a storage medium storing a control program that controls a relay device in a vehicle electric power supply device that includes an electric power storage device that is charged with supplied electric power output from an external electric power supply, the relay device provided between the external electric power supply and the electric power storage device, and an electric current sensor that measures an electric current value of an electric power line that connects the external electric power supply and the electric power storage device. The control program is configured to cause a computer to perform functions of instructing the external electric power supply to stop outputting the supplied electric power when an abnormality in the electric current value is detected during charging of the electric power storage device, and controlling a timing of cutting off a switch of the relay device, based on a state of the electric current value and a state of an amount of electric power charged to the electric power storage device, after the instruction to stop output.

According to the present disclosure, when the vehicle electric power supply device detects an abnormality in the electric current value of the electric power line connecting the external electric power supply and the electric power storage device while the electric power storage device is being charged, the external electric power supply is instructed to stop output of the supplied electric power that is output from the external electric power supply. Further, the vehicle electric power supply device controls the timing of cutting off the switch of the relay device, based on the state of the electric current value of the electric power line and the state of the amount of electric power charged to the electric power storage device, after the instruction to stop output of the supplied electric power. Accordingly, overcharging of the electric power storage device is suppressed, even when an abnormality occurs in the external electric power supply while the electric power storage device is being charged.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration example of a vehicle electric power supply device according to an embodiment;

FIG. 2 is a diagram showing a comparative example of an operation example of the vehicle electric power supply device according to the embodiment;

FIG. 3 is a diagram showing an operation example of the vehicle electric power supply device according to the embodiment;

FIG. 4 is a flowchart showing an example of processing by a control device in the vehicle electric power supply device according to the embodiment; and

FIG. 5 is a flowchart showing an example of processing by the control device in the vehicle electric power supply device according to a modification of the embodiment.

### DETAILED DESCRIPTION OF EMBODIMENTS

A vehicle electric power supply device, a control method in a control device, and a control program, according to an embodiment of the present disclosure, will be described with reference to the accompanying drawings.

### Embodiment

### 1. Configuration Example of Vehicle Electric Power Supply Device

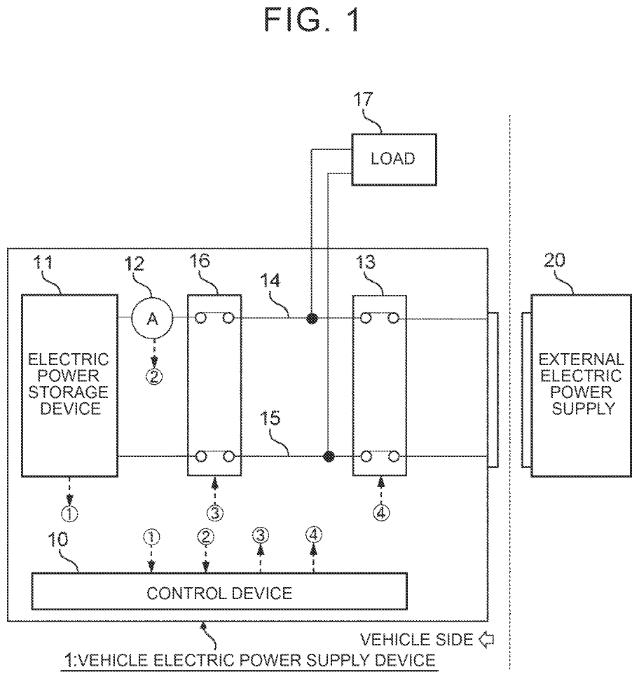

FIG. 1 is a diagram illustrating a configuration example of a vehicle electric power supply device 1 according to the embodiment. The vehicle electric power supply device 1 is installed in a vehicle. The vehicle in which the vehicle electric power supply device 1 is installed is an electrified vehicle that has a drive motor driven by a battery (i.e., an electric power storage device 11). The vehicle may be a manually operated vehicle or an automatically operated vehicle.

As illustrated in FIG. 1, the vehicle electric power supply device 1 installed in the vehicle is connected to an external electric power supply 20, for example. The term “external electric power supply 20” refers to a device that stores electric power obtained from a commercial electric power supply or the like. Examples of the external electric power supply 20 include a quick charger that outputs electric power of around 50 kW, a common charger that outputs electric power below 50 kW, and so forth. The vehicle electric power supply device 1 performs charging by the supplied electric power output from the external electric power supply 20.

The vehicle electric power supply device 1 is connected to a load 17 and to the external electric power source 20 while charging. The vehicle electric power supply device 1 also includes a control device 10, the electric power storage device 11, an electric current sensor 12, a system main relay 16 and a relay device 13. The control device 10 may be provided inside the vehicle electric power supply device 1 as illustrated in FIG. 1, or may be installed the vehicle and provided externally from the vehicle electric power supply device 1.

The electric power storage device 11 is a battery pack in which a plurality of single cells is connected in series, and is connected to each of a positive electric power line 14 and a negative electric power line 15. Note that the electric power storage device 11 may be a device in which a plurality of the battery packs is connected in parallel.

The current sensor 12 is provided between the electric power storage device 11 and the system main relay 16 and is a sensor that measures an electric current value of the positive electric power line 14.

The system main relay 16 is a device that is connected to each of the positive electric power line 14 and the negative electric power line 15, and connects or cuts off electricity between the electric power storage device 11 and the load 17. Specifically, the electric power storage device 11 and the load 17 are electrically connected by switching on a switch of the system main relay 16, and the electric power storage device 11 and the load 17 are electrically cut off by switching off the switch of the system main relay 16. Switching of the switch of the system main relay 16 on and off is controlled by the control device 10, which will be described later.

The relay device 13 is a device that is connected to each of the positive electric power line 14 and the negative electric power line 15, and that connects or cuts off electricity between the vehicle electric power supply device 1 and the external electric power supply 20. Specifically, the vehicle electric power supply 1 and the external electric power supply 20 are electrically connected, by switching on the switch of the relay device 13, and the vehicle power supply device 1 and the external power supply 20 are electrically cut off by switching off the switch of the relay device 13. Switching of the switch of the relay device 13 on and off is controlled by the control device 10, which will be described later.

The control device 10 is a computer that controls the vehicle electric power supply device 1. The control device 10 includes a processor and memory (storage medium) storing a control program (a control program according to the present embodiment) that is executed by the processor. Functions described below are realized in the control device 10 by the processor executing the control program.

The control device 10 is connected to each of the electric power storage device 11, the electric current sensor 12, the system main relay 16, and the relay device 13. The control device 10 can read information regarding the amount of electric power charged to the electric power storage device 11, and information regarding the electric current value of the positive electric power line 14 measured by the electric current sensor 12. The control device 10 also controls switching of the switches of each of the relay device 13 and the system main relay 16 on and off.

The control device 10 has a function of instructing the external electric power supply 20 to stop outputting the supplied electric power output from the external electric power supply 20 when an abnormality in the external electric power supply 20 is detected. The term “abnormality in the external electric power supply 20” means that the electric current value of the positive electric power line 14 is in a state of being no lower than a predetermined value indicating abnormality. The control device 10 has a function of subsequently controlling the timing to cut off the switch of the relay device 13, based on the state of the electric current value of the positive electric power line 14 and the state of the amount of electric power charged to the electric power storage device 11. Details of processing performed by these functions of the control device 10 will be described later.

### 2. Operation Example of Vehicle Electric Power Supply Device

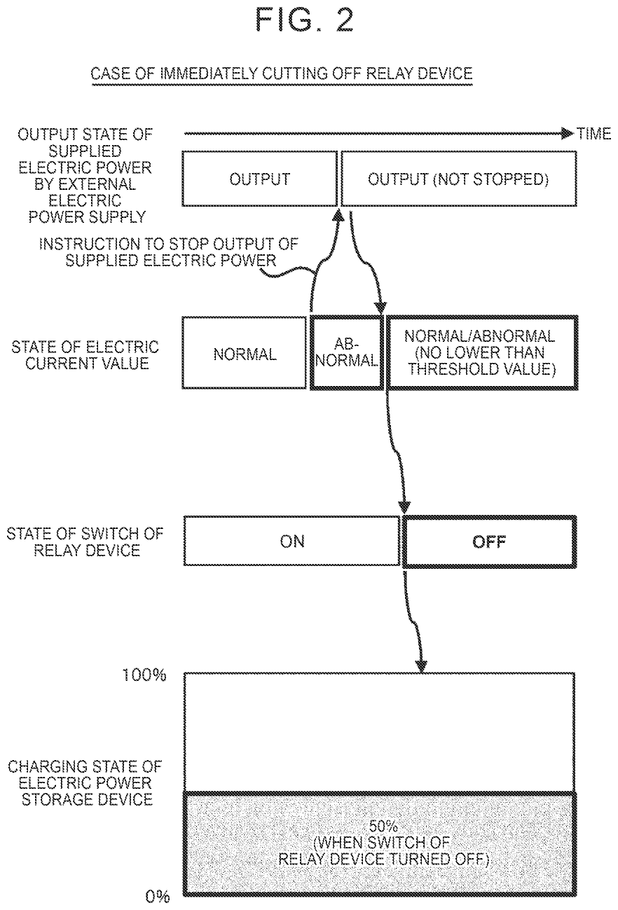

FIG. 2 is a diagram showing a comparative example of an operation example of the vehicle electric power supply device 1 according to the embodiment. Specifically, FIG. 2 shows the comparative example of the operation example of the vehicle electric power supply device 1, from detection of an abnormality in the electric current value of the positive electric power line 14, to switching off the switch of the relay device 13. The comparative example of the operation example of the vehicle electric power supply device 1 will be described below.

According to FIG. 2, when the external electric power supply 20 does not stop outputting the supplied electric power even though the external electric power supply 20 is instructed to stop outputting the supplied electric power following detection of the abnormality in the electric current value of the positive electric power line 14, the relay device 13 is immediately cut off.

Specifically, after an abnormality in the electric current value of the positive electric power line 14 is detected, the external electric power supply 20 is instructed to stop outputting the supplied electric power. Thereafter, when determination is made that the electric current value of the positive electric power line 14 is no lower than a threshold value, the switch of the relay device 13 is switched off. That is to say, even when the proportion of the amount of the electric power charged to the electric power storage device 11 is around 50%, for example, which is lower than the proportion of the amount of electric power planned to be charged, and the electric power storage device 11 has sufficient chargeable capacity, the switch of the relay device 13 is switched off, and charging of the electric power storage device 11 is interrupted. Note that the electric current value when output of the supplied electric power supply, which is output from the external electric power supply 20, is not stopped may be normal or may be abnormal.

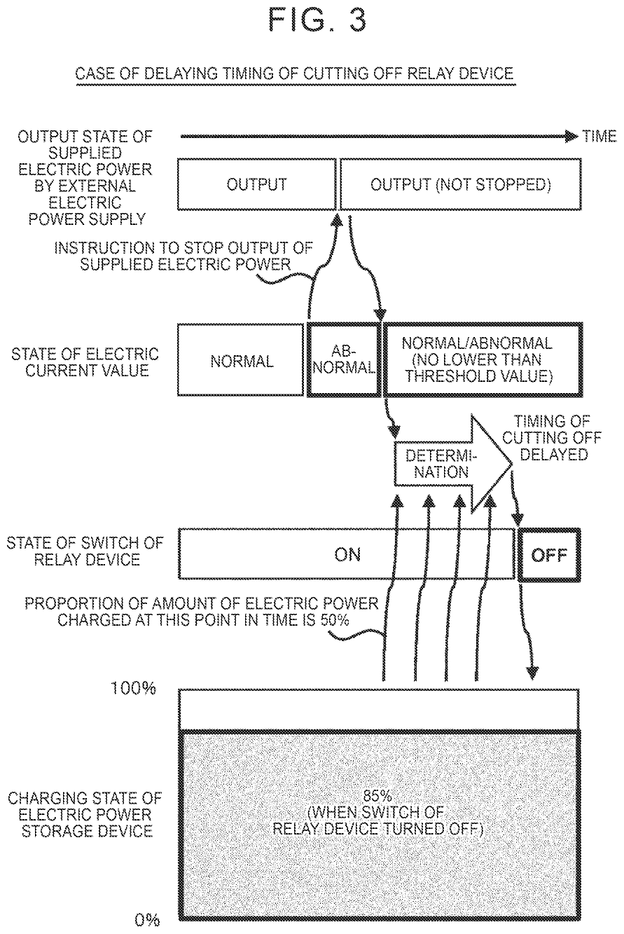

FIG. 3 is a diagram showing an operation example of the vehicle electric power supply device 1 according to the embodiment. Specifically, FIG. 3 shows operation example of the vehicle electric power supply device 1, from detection of an abnormality in the electric current value of the positive electric power line 14, to switching off the switch of the relay device 13. The operation example of the vehicle electric power supply device 1 will be described below.

According to FIG. 3, when the external electric power supply 20 does not stop outputting the supplied electric power even though the external electric power supply 20 is instructed to stop outputting the supplied electric power following detection of the abnormality in the electric current value of the positive electric power line 14, the relay device 13 is cut off at a delayed timing.

Specifically, after detection of an abnormality in the electric current value of the positive electric power line 14, the vehicle electric power supply device 1 instructs the external electric power supply 20 to stop outputting the supplied electric power. Thereafter, when determination is made that the electric current value of the positive electric power line 14 is no lower than the threshold value, the vehicle electric power supply device 1 switches off the switch of the relay device 13 after a certain amount of time has elapsed.

More specifically, the vehicle electric power supply device 1 keeps the switch of the relay device 13 on, in a case in which the amount of electric power charged to the electric power storage device 11 will not exceed the amount of electric power for a full charge during elapsing of a certain amount of time after the external electric power supply 20 is instructed to stop outputting the supplied electric power and the electric current value of the positive electric power line 14 is no lower than the threshold value. That is to say, when the proportion of the amount of electric power charged to the electric power storage device 11 is around 50%, for example, which is lower than the proportion of the amount of electric power planned to be charged, and the amount of electric power charged to the electric power storage device 11 does not exceed the amount of electric power for a full charge, the switch of the relay device 13 is kept on, and charging of the electric power storage device 11 is continued. Thereafter, when determination is made that the proportion of the amount of electric power charged to the electric power storage device 11 has reached 85%, for example, which is the proportion of the amount of electric power planned to be charged, the vehicle electric power supply device 1 switches off the switch of the relay device 13.

Thus, when the external electric power supply 20 does not stop outputting the supplied electric power even though the external electric power supply 20 is instructed to stop outputting the supplied electric power following detection of the abnormality in the electric current value of the positive electric power line 14, the relay device 13 is immediately cut off according to the comparative example of the operation example of the vehicle electric power supply device 1 shown in FIG. 2. However, the relay device 13 does not have to be cut off immediately as long as electric current value of positive electric power line 14 is of a level at which fusing of the relay device 13 will not occur. Rather, cutting off the relay device 13 immediately is undesirable when giving consideration to shortening the charging time.

Thus, according to the vehicle electric power supply device 1 of the embodiment, the timing to cut off the switch of the relay device 13 is controlled based on the state of the electric current value of the positive electric power line 14, and the state of the amount of electric power charged to the electric power storage device 11, following instruction to the external electric power supply 20 to stop output of the supplied electric power, as shown in FIG. 3. This enables overcharging of the electric power storage device 11 to be suppressed, even when an abnormality occurs in the external electric power supply 20 while the electric power storage device 11 is being charged.

### 3. Processing Example of Control Device

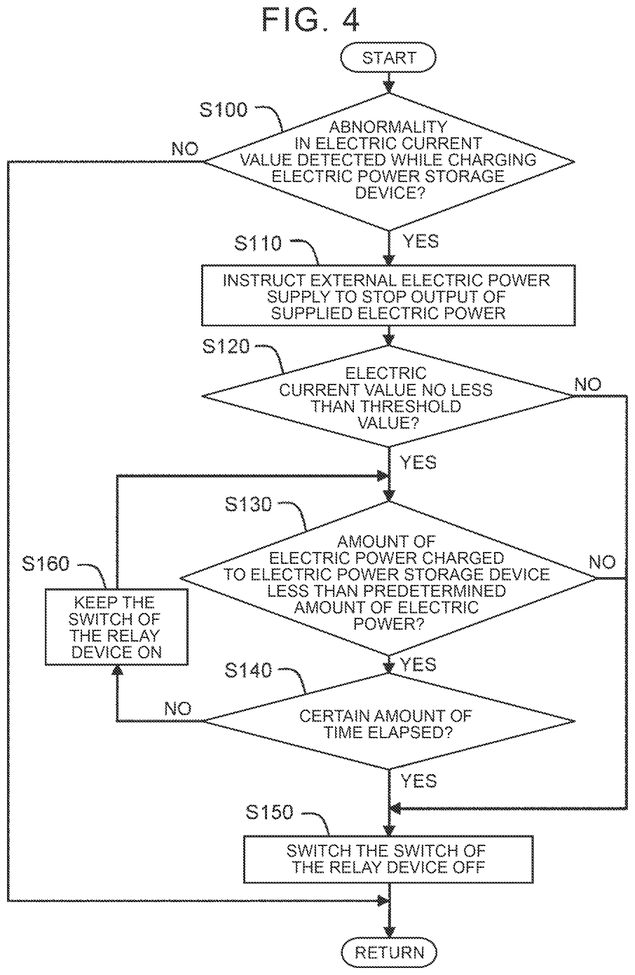

FIG. 4 is a flowchart showing an example of processing by the control device 10 in the vehicle electric power supply device 1 according to the embodiment. As described above, the processor executes the following processing by executing the control program. The following series of processing represents a control method (control method according to the present embodiment) implemented by the control device 10.

In step S100, the control device 10 determines whether an abnormality in the electric current value of the positive electric power line 14 is detected while charging the electric power storage device 11. When determination is made that an abnormality has been detected in the electric current value of the positive electric power line 14, the processing advances to step S110. Otherwise, the processing ends.

In step S110, the control device 10 instructs the external electric power supply 20 to stop outputting the supplied electric power output from the external power supply 20. Thereafter, the processing advances to step S120.

In step S120, the control device 10 determines whether the electric current value of the positive electric power line 14 no lower than the threshold value. When determination is made that the electric current value of the positive electric power line 14 is no lower than the threshold value, the processing advances to step S130. Otherwise, the processing advances to step S150.

In step S130, the control device 10 determines whether the amount of electric power charged to the electric power storage device 11 is less than a predetermined amount of electric power. When determination is made that the amount of electric power charged to the electric power storage device 11 is less than the predetermined amount of electric power, the processing advances to step S140. Otherwise, the processing advances to step S150.

In step S140, the control device 10 determines whether a certain amount of time has passed since the electric current value of the positive electric power line 14 became no lower than the threshold value. When determination is made that the certain amount of time has elapsed since the electric current value of the positive electric power line 14 became no lower than the threshold value, the processing advances to step S150. Otherwise, the processing advances to step S160.

In step S160, the control device 10 keeps the switch of the relay device 13 on. Thereafter, the processing returns to step S130. That is to say, the switch of the relay device 13 is kept on as long as the amount of electric power charged to the electric power storage device 11 is less than the predetermined amount of electric power, and the certain amount of time has not elapsed from when the electric current value of the positive electric power line 14 became no lower than the threshold value.

In step S150, the control device 10 switches the switch of the relay device 13 off. That is to say, the switch of the relay device 13 is switched off when the certain amount of time elapses after the electric current value of the positive electric power line 14 becomes no lower than the threshold value, or when the amount of electric power charged to the electric power storage device 11 is no less than the predetermined amount of electric power. Thereafter, the processing ends.

### 4. Modifications

In the control device 10 in the vehicle electric power supply device 1 according to the embodiment, the switch of the relay device 13 is kept on until the certain amount of time from when the electric current value of the positive electric power line 14 becomes no lower than the threshold value elapses, when the amount of electric power charged to the electric power storage device 11 is less than the predetermined amount of electric power. However, even after the certain amount of time has elapsed since the electric current value of the positive electric power line 14 became no lower than the threshold value, the switch of the relay device 13 may be kept on when the amount of electric power charged to the electric power storage device 11 is less than the predetermined amount of electric power.

Thus, according to the control device 10 in the vehicle electric power supply device 1 of to the modification of the embodiment, the switch of the relay device 13 is kept on until the amount of electric power charged to the electric power storage device 11 after the electric current value of the positive electric power line 14 becomes no lower than the threshold value is no less than the predetermined amount of electric power. Thus, the same effects as those of the vehicle electric power supply device 1 according to the above-described embodiment can be obtained. A processing example of the control device 10 according to the modification will be described below.

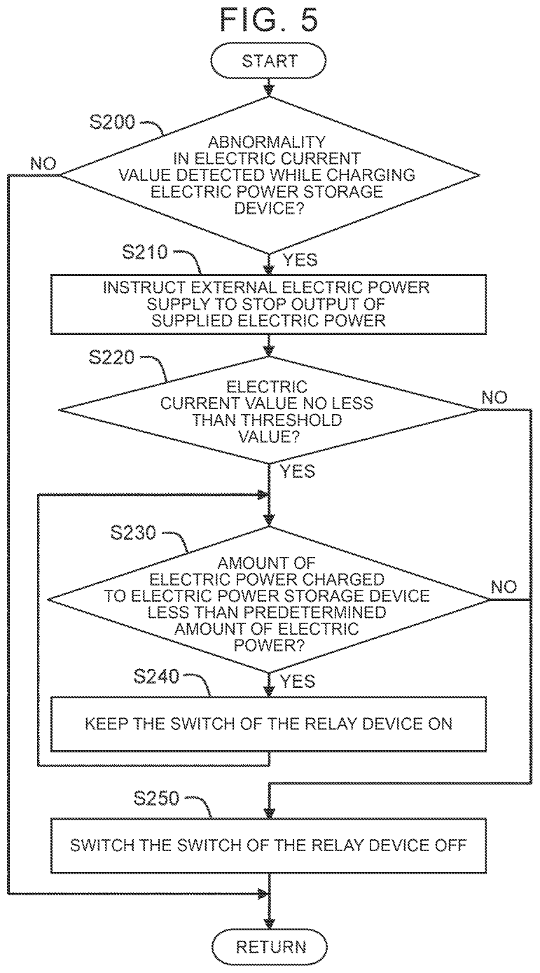

FIG. 5 is a flowchart showing an example of processing by the control device 10 in the vehicle electric power supply device 1 according to the modification of the embodiment. As described above, the processor executes the following processing by executing the control program. The following series of processing represents a control method (control method according to the present embodiment) implemented by the control device 10.

In step S200, the control device 10 determines whether an abnormality in the electric current value of the positive electric power line 14 is detected while charging the electric power storage device 11. When determination is made that an abnormality has been detected in the electric current value of the positive electric power line 14, the processing advances to step S210. Otherwise, the processing ends.

In step S210, the control device 10 instructs the external electric power supply 20 to stop outputting the supplied electric power output from the external electric power supply 20. Thereafter, the processing advances to step S220.

In step S220, the control device 10 determines whether the electric current value of the positive electric power line 14 no lower than the threshold value. When determination is made that the electric current value of the positive electric power line 14 is no lower than the threshold value, the processing advances to step S230. Otherwise, the processing advances to step S250.

In step S230, the control device 10 determines whether the amount of electric power charged to the electric power storage device 11 is less than the predetermined amount of electric power. When determination is made that the amount of electric power charged to the electric power storage device 11 is less than the predetermined amount of electric power, the processing advances to step S240. Otherwise, the processing advances to step S250.

In step S240, the control device 10 keeps the switch of the relay device 13 on. Thereafter, the processing returns to step S230. That is to say, the switch of the relay device 13 is kept on as long as the amount of electric power charged to the electric power storage device 11 is less than the predetermined amount of electric power.

In step S250, the control device 10 switches the switch of the relay device 13 off. That is to say, the switch of the relay device 13 is switched off when the electric current value of the positive electric power line 14 is lower than the threshold value, or when the amount of electric power charged to the electric power storage device 11 is no less than the predetermined amount of electric power. Thereafter, the processing ends.

What is claimed is:

1. A vehicle electric power supply device comprising:
an electric power storage device that is charged with supplied electric power output from an external electric power supply;
a relay device provided between the external electric power supply and the electric power storage device;
an electric current sensor that measures an electric current value of an electric power line that connects the external electric power supply and the electric power storage device; and
a control device that is connected to each of the electric power storage device, the relay device, and the electric current sensor, and that controls the relay device, wherein the control device is configured to
instruct the external electric power supply to stop outputting the supplied electric power when an abnormality in the electric current value is detected during charging of the electric power storage device, and
control a timing of cutting off a switch of the relay device, based on a state of the electric current value and a state of an amount of electric power charged to the electric power storage device, after the instruction to stop output.

2. The vehicle electric power supply device according to claim 1, wherein the control device is configured to, after the instruction to stop output, keep the switch of the relay device on until a certain amount of time elapses from when the electric current value becomes no lower than a threshold value, when the amount of electric power charged to the electric power storage device is less than a predetermined amount of electric power.

3. The vehicle electric power supply device according to claim 1, wherein the control device is configured to, after the instruction to stop output, keep the switch of the relay device on from when the electric current value becomes no lower than a threshold value, until the amount of electric power charged to the electric power storage device becomes no less than a predetermined amount of electric power.

4. A control method of controlling a relay device in a vehicle electric power supply device that includes an electric power storage device that is charged with supplied electric power output from an external electric power supply, the relay device provided between the external electric power supply and the electric power storage device, and an electric current sensor that measures an electric current value of an electric power line that connects the external electric power supply and the electric power storage device, the method comprising:
instructing the external electric power supply to stop outputting the supplied electric power when an abnormality in the electric current value is detected during charging of the electric power storage device; and
controlling a timing of cutting off a switch of the relay device, based on a state of the electric current value and a state of an amount of electric power charged to the electric power storage device, after the instruction to stop output.

5. A non-transitory storage medium storing a control program that is configured to cause a computer to perform functions of controlling a relay device in a vehicle electric power supply device that includes an electric power storage device that is charged with supplied electric power output from an external electric power supply, the relay device provided between the external electric power supply and the electric power storage device, and an electric current sensor that measures an electric current value of an electric power line that connects the external electric power supply and the electric power storage device, the functions comprising:
instructing the external electric power supply to stop outputting the supplied electric power when an abnormality in the electric current value is detected during charging of the electric power storage device; and
controlling a timing of cutting off a switch of the relay device, based on a state of the electric current value and a state of an amount of electric power charged to the electric power storage device, after the instruction to stop output.
